(19) United States
(12) Patent Application Publication
(10) Pub. No.: US 2009/0282444 A1
(43) Pub. Date: Nov. 12, 2009

(54) SYSTEM AND METHOD FOR MANAGING THE PRESENTATION OF VIDEO

(75) Inventors: Indra Laksono, Richmond Hill (CA); Hai Hua, Markham (CA); SuiWu Dong, Markham (CA); Xu Gang Zhao, Toronto (CA); Haibo Liu, Scarborough (CA); Song Jin, Scarborough (CA)

Correspondence Address: LARSON NEWMAN & ABEL, LLP, 5914 WEST COURTYARD DRIVE, SUITE 200, AUSTIN, TX, 78730, US

(73) Assignee: VIXS SYSTEMS, INC., Toronto (CA)

(21) Appl. No.: 12/507,622

(22) Filed: Jul. 22, 2009

Related U.S. Application Data
(62) Division of application No. 10/004,770, filed on Dec. 4, 2001.

(51) Int. Cl. H04N 7/173

(52) U.S. Cl. 725/89; 725/88

(57) ABSTRACT

A system and a method to manage the presentation of video to one or more display clients are disclosed herein. The video can be presented in a fast forward presentation mode, a fast reverse presentation mode, and a reverse presentation mode. Additionally, the presentation of the video can be paused and then resumed, or shifted by a certain time or number of frames. In at least one embodiment, a frame index is utilized when changing the presentation rate or the direction of the presentation. The frame index can be used to identify and/or locate certain frames of the video. Once located and/or identified, the order of the frames can be manipulated and/or a subset of the frames can be selected to generate different presentation modes of the video.

### CROSS-REFERENCE TO RELATED APPLICATIONS

The present application is a divisional continuing application of U.S. patent application Ser. No. 10/004,770 (Attorney Docket No. 1459-VIXS032), filed on Dec. 4, 2001 and entitled “System and Method for Managing the Presentation of Video,” the entirety of which is incorporated by reference herein.

### FIELD OF THE DISCLOSURE

The present disclosure relates generally to providing video and more particularly to providing video using a variety of presentation modes.

### BACKGROUND

Changing the presentation of encoded video in real-time, such as displaying the video at a fast forward playback or reverse playback (commonly referred to as “trick modes”), often presents a number of problems. One problem is that many systems have constraints that limit their abilities to display the video using different presentation modes. For example, some systems, such as DVD players, implement a fast forward presentation mode by simply decoding and displaying every encoded frame at an increased rate, such as twice as fast to generate a two times (2×) fast forward presentation rate. However, other systems may be unable to receive and/or decode data at such a rate. For example, the bandwidth between a video server and a display client may be limited. Similarly, the display client may have a decoder that is incapable of decoding encoded frames at such a rate.

Another potential problem is that a network connecting the video server and the display clients could be subject to variable length latency present in many general purpose data networks that would pose problems for real-time user response to presentation sequence requests. Such variable length latency could make it difficult for common video navigation methods that provide video to display clients from a central server to respond to presentation requests from display clients in a timely fashion; a user of a display client must be able to request a pause, fast forward, or rewind in the presentation of the video and get nearly-instantaneous response in the same way typical non-networked devices work.

Yet another problem is that the properties and/or the location of encoded frames of the video are often difficult to determine in real-time, thereby limiting the ability of a system to present video in certain presentation modes. For example, in a reverse playback a reference frame for a forward predicted frame is generally needed to decode the forward predicted frame. However, without prior knowledge of the location of the necessary reference frame, considerable time could be spent by the system while searching for the reference frame.

Given these limitations, as discussed, it is apparent that an improved system and/or method to manage the presentation of video would be advantageous.

### BRIEF DESCRIPTION OF THE FIGURES

Various advantages, features and characteristics of the present disclosure, as well as methods, operation and functions of related elements of structure, and the combination of parts and economies of manufacture, will become apparent upon consideration of the following description and claims with reference to the accompanying drawings, all of which form a part of this specification.

FIG. 1 is a block diagram illustrating a system to manage the presentation of video in accordance with at least one embodiment of the present disclosure;

FIG. 2 is a block diagram illustrating various methods of transmitting presentation requests in accordance with at least one embodiment of the present disclosure;

FIG. 3 is a block diagram illustrating in greater detail a video server illustrated in FIG. 1 in accordance with at least one embodiment of the present disclosure;

FIG. 4 is a block diagram illustrating a method for generating a frame index in accordance with at least one embodiment of the present disclosure;

FIG. 5 is a block diagram illustrating a method of generating a fast forward presentation of video in accordance with at least one embodiment of the present disclosure;

FIG. 6 is a block diagram illustrating a method of generating a fast reverse presentation of video in accordance with at least one embodiment of the present disclosure;

FIG. 7 is a block diagram illustrating a method of displaying a subset of frames in reverse order to generate a fast reverse presentation in accordance with at least one embodiment of the present disclosure;

FIG. 8 is a block diagram illustrating a method of generating a reverse presentation of video in accordance with at least one embodiment of the present disclosure;

FIG. 9 is a block diagram illustrating a method of displaying a subset of frames at a start of a video stream in reverse order to generate a reverse presentation in accordance with at least one embodiment of the present disclosure;

FIG. 10 is a block diagram illustrating a method of displaying a subset of frames subsequent to a start of a video stream in reverse order to generate a reverse presentation in accordance with at least one embodiment of the present disclosure; and

FIGS. 11-15 are block diagrams illustrating a method of pausing a presentation of video in accordance with at least one embodiment of the present disclosure.

### DETAILED DESCRIPTION OF THE FIGURES

In accordance with the present disclosure, video data is received, the video data including a plurality of frames having a first presentation sequence. A frame index having a plurality of frame index entries corresponding to the plurality of frames is generated. Using the frame index, a subset of frames of the plurality of frames is determined based on a second presentation sequence. Each frame of the subset of frames is provided to a display client based on the second presentation sequence. One advantage in accordance with a specific embodiment of the present disclosure is that video having various presentation modes can be implemented in real-time. Another advantage is that video having various presentation modes can be provided to display clients having limited capabilities. Another advantage is that a reduced bandwidth is used to provide the video to display clients.

Note that in the following discussion the terms “frame” and “field” are used interchangeably to refer to an atomic picture unit. The term “frame” is generally used in reference to progressive display systems and the term “field” is generally is used in reference to interlaced display systems. A frame can be taken mean an odd and even field in an interlaced display system. A picture can be either a frame or a field. It is known in the art that video compression formats such as MPEG are capable of compressing video in field or frame picture formats. For ease of discussion, the term frame is used to refer to a field, frame, or picture. The methods and systems disclosed refer to consecutive temporally ordered sequential pictures regardless of the display system used, whether progressive display or interlaced display.

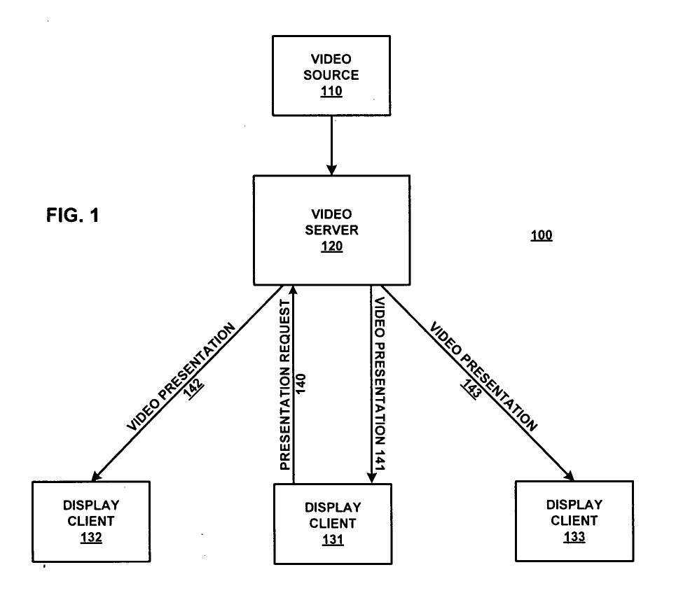

FIGS. 1-15 illustrate a system and a method to manage the presentation of video to one or more display clients, such as televisions, handheld display devices, and the like. The video can be presented in a fast forward presentation mode, a fast reverse presentation mode, and a reverse presentation mode. Additionally, the presentation of the video can be paused and then resumed. In at least one embodiment, a frame index is utilized when changing the presentation rate or the direction (i.e. forward to reverse and vice versa) of the presentation. The frame index can be used to identify and/or locate certain frames of the video. Once located and/or identified, the order of the frames can be manipulated and/or a subset of the frames can be selected to generate different presentation modes of the video.

Referring now to FIG. 1, a system for managing the presentation of video is illustrated in accordance with at least one embodiment of the present disclosure. System 100 includes video source 110, video server 120, and one or more display clients 131-133. Video source 110 can include one of a variety of video data sources, such as a multimedia server connected to the Internet, a cable television provider, a satellite television provider, a video cassette player, a digital video disc (DVD) player, and the like. Display clients 131-133 can include a variety of display devices, such as notebook computers, desktop computers, television devices, personal digital assistants, and the like. Video server 120 includes a system for providing video from video source 110 to display clients 131-133. In at least one embodiment, video server 120 is remote to one or more of display clients 131-133. For example, video server 120 could be implemented to provide streaming video across the Internet. In this case, video source 110 could include a satellite television head-in connected to a multimedia server (video server 120) on the Internet. Display clients 131-132, such as portable display devices, could then connect to the multimedia server via a wireless network implementing an 802.11 protocol. Likewise, video server 120 could be implemented as a transcoder to transcode encoded video received from video source 110 and provide the transcoded video the display clients 131-132. In at least one embodiment, display clients 131-133 can direct the presentation of the video using one or more traditional presentation commands used by certain video systems, such a video cassette player. These presentation commands include fast forward, fast reverse, reverse, pause, and jump.

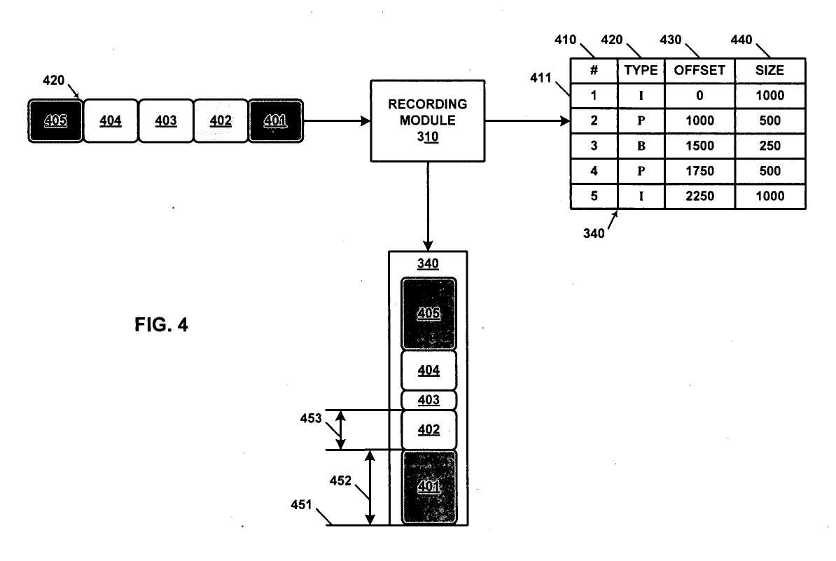

As illustrated in FIG. 1, in at least one embodiment, a display client initiates a change in the presentation of video content being streamed to the display client by submitting a presentation request to video server 120, such as presentation request 140 from display client 131. The presentation request can include a data representation of a presentation command initiated by input from a user. For example, streaming video from video server 120 could be displayed using a graphical user interface on display client 131 as video presentation 141 and the GUI can include a number of presentation control buttons, such as a fast forward button, a fast reverse button, a reverse button, a play button, a stop button, and a pause button. In this case, the transmission of presentation request 140 could be initiated by the user selecting one of the presentation control buttons, for example, the fast forward button. Video server 120 receives the request for a change in the presentation of the streaming video and provides the video to the display client in the requested presentation mode as video presentation 142. For example, if representation request 140 includes a request for the content of the video to be presented at two times (2×) the normal display rate, the video content could be provided as video presentation 141 such that it is displayed on display client 131 at a perceived 2× rate. Similarly, the content of the video could be presented in a fast reverse presentation mode to display client 132 as video presentation 142 and in a normal speed reverse presentation mode to display client 133 as video presentation 143. Methods for implementing presentation commands are illustrated in greater detail with reference to FIGS. 4-14.

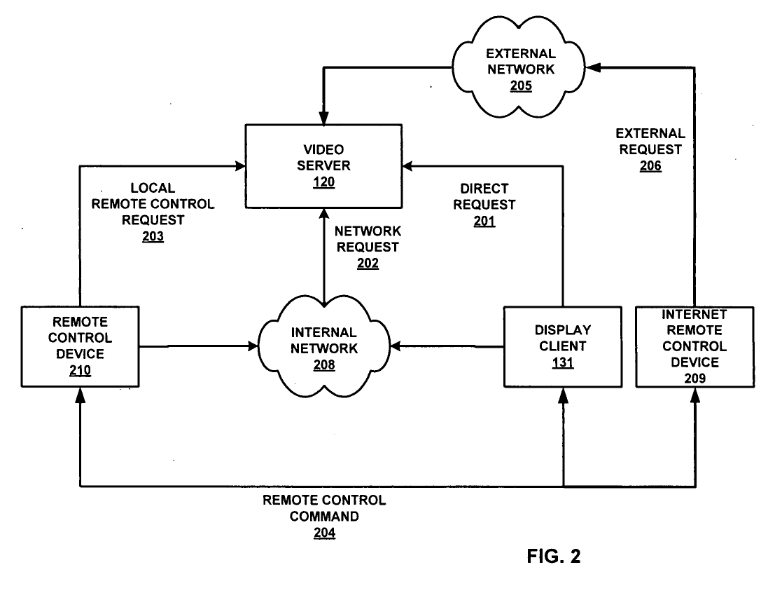

Referring to FIG. 2, a variety of methods for transmitting a presentation request from a display client to a video server are illustrated in accordance with at least one embodiment of the present disclosure. In one embodiment, display client 131 is directly connected to video server 120. For example, display client 131 can include a high-definition television (HDTV) connected via video cables to a cable box (an example of video server 120). In this case, the presentation request can be transmitted to video server 120 directly as direct request 201. Direct request 201 can be transmitted over the same pipe that video server 120 uses to provide the video to display client 131. Alternatively, a separate command pipe can be created to receive the presentation request from display client 131. In another embodiment, display client 131 is remote to video server 120 and display client 131 is connected to video server 120 via an internal network 208, which can include a local area network, a wireless network, and the like. In this case, the presentation request can be sent as network request 202 from display client 131 to video server 120 via internal network 208.

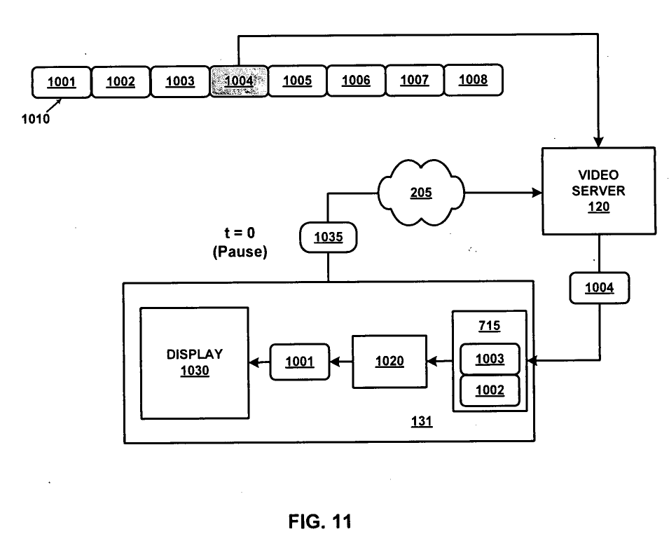

Rather than direct a presentation request directly from display client 131 to video server 120, in one embodiment, display client 131 provides remote control command 204 to a local remote control device 210. Remote control device 210, in turn, interprets remote control command 204 and provides video server 120 with a presentation request (local remote control request 203) for display client 131. For example, remote control device 210 can include an infrared receiver (IR), which receives presentation commands from an IR remote control operated by a user of display client 131. Local remote control request 203 can be provided directly to video server 120 or via network 208 as network request 202. Alternatively, display client 131 could be connected to a remote control device (Internet remote control device 209) that is connected to an external network 205, such as the Internet. In this case, a presentation request can be provided to Internet remote control device 209 as remote control command 204. Internet remote control device 209 can then translate remote control command 204 and send the associated presentation request to as external request 206 to video server 120 via external network 208. It will be appreciated that external network 205 and/or internal network 208 can introduce a significant delay between the transmission of the presentation request by display client 131 and the receipt by video server 120. Accordingly, in at least one embodiment, the presentation request (network request 202 or external request 206) includes a time marker or frame marker to indicate the time of transmission to video server 120. Methods to minimize the latency problems caused by this delay are addressed with reference to FIGS. 11-15.

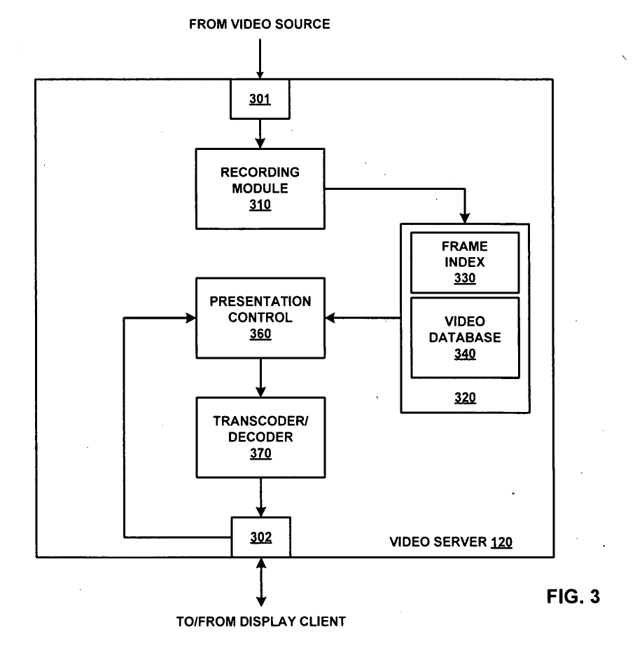

Referring to FIG. 3, video server 120 is illustrated in greater detail in accordance with at least one embodiment of the present disclosure. Video server 120 includes input interface 301, output interface 302, recording module 310, storage 320, frame index 330, video database 340, presentation control 360, and transcoder 370. Elements of video server 120 can be implemented as software, hardware, firmware, or a combination thereof. For example, video server 120 can be implemented as a set of executable instructions (i.e. software) ran in conjunction with a hardware motion pictures experts group (MPEG) transcoder.

In at least one embodiment, video data is received by input interface 301 from a video source, such as video source 110 of FIG. 1. The video data can include compressed video data, such as MPEG encoded video data from a DVD player, decoded or unencoded video data, such as analog television signals, and the like. The video data is provided to recording module 310 for processing. Recording module 310 can include a video encoder, a video decoder, a video transcoder, and the like. For example, if the received video data is an analog television signal, recording module 310 can include a MPEG encoder to convert the analog television signal to MPEG encoded data. Likewise, recording module 310 can include a transcoder to transcode received MPEG encoded video data. After receiving the video data and modifying the received data, as necessary, recording module 310 can store the received video data in storage 320 in the same form as it is received or in a compressed or transcoded form. For example, recording module 310 can store the received video data as MPEG encoded video data, or decode encoded MPEG data and store it as decompressed video data.

In at least one embodiment, recording module 310 generates frame index 330 from the received video data, where frame index 330 includes a plurality of frame index entries for the frames of the received video data. A frame index entry can include the frame type, such as intraframe (I-frame), a forward predicted frame (P-frame), or bi-directional predicted frame (B-frame). The frame index entry can also include an indication of the location of the frame within the video data. For example, each frame index entry of frame index 330 can include an offset value from a starting point of a file used to store the video data and/or a size value to describe the location and the size of the associated frame. As discussed in greater detail subsequently, frame index 330 can be used to implement one or more presentation modes in real-time by allowing desired frames to be located and/or identified relatively quickly.

In one embodiment, recording module 310 stores a version of the received video data in video database 340. For example, if the received video data is analog television data, then recording module 310 could encode the analog television data to generate MPEG encoded video data and store the MPEG encoded video data in video database 340. Likewise, if the received video data is compressed video data, recording module 310 can include a decoder to decompress the encoded video data and then store the decompressed video data in video database 340. Alternatively, recording module 310 can store the received video data in video database 340 in an unmodified form.

Rather than store a version of the received video data, in at least one embodiment, the received video data is not stored in storage 320 after the associated frame index 330 is generated. The received video data could include MPEG data from a DVD player and since the MPEG data is already conveniently stored on a DVD, the MPEG data need not be stored in duplicate. In this example, the MPEG data could be received from the DVD and provided to recording module 310 a first time to generate frame index 330, and then retrieved subsequently from the DVD and provided to one or more display clients. In this case, certain values of the frame index entries of the frame index, such as the frame offset, can be based on the storage of the data on the video source.

In at least one embodiment, frame index 330 and/or video database 340 are implemented and/or stored on storage 320, where storage 320 can include memory, a buffer, magnetic storage, optical storage, and the like. For example, storage 320 could be implemented as system random access memory (RAM), and frame index 330 could be implemented as a data structure permanently stored in a hard disk but temporarily stored in system RAM during use.

After frame index 330 for the received video data has been generated, the received video data, or a version thereof, can be provided to one or more display clients, such as display clients 131-133 (FIG. 1). Until directed otherwise by a display client, presentation control 360 retrieves the video data from video database 340 and/or the video source and streams the video data at a “normal” presentation rate to the display clients via transcoder 370 and output interface 302. The term normal presentation rate refers to a real-time display of the video data as received from a video source. Transcoder 370 can be used in instances where the video data stored in video database 340 or at the video source is to be modified. For example, transcoder 370 can reduce the resolution of the video data, drop frames, and the like. Similarly, in one embodiment, transcoder 370 can include a MPEG decoder to decode MPEG video data and provide the video data in a decompressed format to a display client.

When the user of a display client wants to change the presentation of the video, such as by viewing the streaming video in fast reverse or fast forward, a presentation request, such as presentation request 140 (FIG. 1), is transmitted from the display client to video server 120 and received by output interface 302. The presentation request is provided to presentation control 360 for interpretation. After determining the requested presentation mode, presentation control 360, in at least one embodiment, utilizes frame index 330 to select a subset of the frames of the received video data and to modify the sequencing of the subset of frames. The modified subset of frames can then be provided to the display client in a manner consistent with the desired presentation mode. Methods for using frame index 330 to generate different presentation modes are illustrated in FIGS. 4-14.

Referring to FIG. 4, a method to generate a frame index is illustrated in accordance with at least one embodiment of the present disclosure. As discussed previously, in one embodiment, a recording module, such as recording module 310 (FIG. 3), receives encoded video data (or generates encoded video data from unencoded video data) and generates a frame index based on the frames of the encoded video data. As demonstrated in FIG. 4, encoded video data 420, having frames 401-405, is received by recording module 310, with frame 401 being the first frame of the video and frame 405 being the last frame of the forward presentation sequence of encoded video data 420. In this illustration, frames 401 and 405 represent I-frames, frames 402 and 404 are B-frames, and frame 403 is a P-frame. As frames 401-405 are received, they are stored in video database 340. Recall that, in one embodiment, encoded video data 320 is analyzed by recording module 310 to generate frame index 330 but is not stored in video database 340.

As each frame of encoded video data 420 is received by a video server, a frame index entry is generated for each received frame of encoded video data 420, such as frame index entry 411 for frame 401. In one embodiment, a frame index entry includes frame order value 410, frame type value 420, frame offset value 430, and frame size value 440. Frame order value 410 indicates the ordering of the frames within the received presentation sequence. As illustrated, frame index entry 411 is assigned a frame order value of 1 since it is the first frame to be received in a normal forward presentation sequence, the frame index entry associated with frame 402 is assigned a frame order value of 2 since it is the second frame to be presented, and so on. Note that the frame order value does not necessarily represent the order by which the associated frame is received. In some cases, a frame later in a received presentation sequence is received by a display client before a frame earlier in a frame sequence. For example, data representing the later frame could be transmitted over a let congested network path than the data representing the earlier frame, resulting in the data representing the later frame arriving first. Accordingly, in this case, the ordering of the frames is the intended sequencing of the frames.

In addition to the frame order, the frame type of each incoming frame can be determined. For example, since frame 401 is an intraframe, a value representing an intraframe is stored as frame type value 420 of the associated frame index entry 411. The frame type can be determined by directly examining the data representing the frame, such as the frame type value stored in the header of MPEG encoded frame data, or the frame type could be determined based on the location of the frame in a sequence of frames. For example, if the sequence by which frames 401-405 is transmitted is known, such as the repeating sequence of I-frame [symbol] P-frame [symbol] B-frame [symbol] B-frame (IPBB), then the third frame received could be determined to be a B-frame based on the known sequence.

Frame offset value 430 represents the offset of the start of the associated frame from a specified point of reference and frame size value 440 represents the data size of the associated frame. The specified point of reference could include the header of a linear file, a starting location on a compact disc or DVD, and the like. For example, frame offset value 430 could be based on file start location 351 of video database 340. For frame 402, the associated frame offset value is represented by offset 452 and the associated frame size value 440 is represented by size 453. Using the frame offset value 430 and frame size value 440, each frame can be accessed relatively quickly from video database 340 or from a video source (such as a DVD player) since its location (frame offset value 430) and data size (frame size value 440) are known. Frame index 330 can include other data descriptors without departing from the spirit or the scope of the present disclosure. For example, frame index 330 can include an indicator for each frame to indicate if each respective frame is critical to the entire video and whether it can be removed for purposes of video length contraction. For example, in some TV networks, shrinking the running length of a video will allow more time for advertising. Accordingly, in at least one embodiment of the present invention, this indicator can be used to inform a video system which individual frames can be deleted without an adverse effect on the entire viewing experience, thereby allowing advertisements to be inserted without increasing the overall display time of the video. Other descriptors can be used as tags into other rich informational content such as Internet links that allows a concurrent information stream to be attached to the video starting at an individual frame.

A number of terms related to the sequencing of frames are discussed in the present disclosure. The term “presentation sequence”, as used herein, refers to the sequencing of encoded frames before decoding, whereas the term “display sequence”, as used herein, refers to the display sequence of decoded or unencoded frames. In a normal forward presentation mode, the presentation sequence and the display sequence of received video data are often different. For example, encoded frames are often transmitted in the presentation sequence of I-frame [symbol] P-frame [symbol] B-frame, but when decoded are displayed in the display sequence of I-frame [symbol] B-frame [symbol] P-frame due to the bi-directional prediction methods used to encode B-frames. Likewise, a reverse presentation sequence and a reverse display sequence are often different, as discussed in greater detail subsequently. However, in the absence of B-frames, the presentation sequence and the display sequence of video data generally include the same sequence. Also note the term “normal” refers to the real-time presentation of the video content of the video data received by video provider 120 from a video source. For example, if the received data uses 30 frames to represent a second of video content, then displaying the 30 frames in one second is considered the “normal” rate. Alternatively, the “fast” rate refers to displaying the video content at a speed faster than the “normal” rate. For example, the 30 frames could be displayed in one-half second, or a subset of the frames could be displayed in one-half second to represent all of the 30 frames, thereby giving the presentation of the video content a two-times (2×) fast forward presentation rate since the video content is displayed at twice the normal rate.

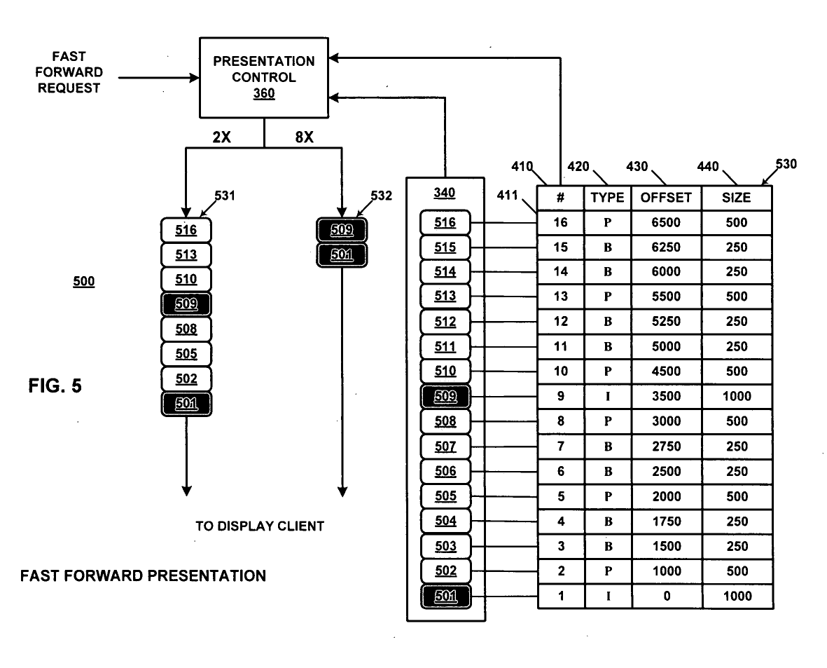

Referring to FIG. 5, a method for implementing a fast forward presentation mode is illustrated in accordance with at least one embodiment of the present disclosure. As illustrated with fast forward scenario 500, frames 501-516 are stored in video database 340. In fast forward scenario 500, frames 501 and 509 are I-frames, frames 502, 505, 508, 510, 513, and 516 are P-frames, and frames 503, 504, 506, 507, 511, 512, 514, and 515 are B-frames. In this example, the associated frame index 530 having frame index entries corresponding to frames 501 501-516, such as frame index entry 411 associated with frame 516, was generated at the same time as frames 501-516 were stored in video database 340.

In a normal presentation sequence, frames 501-516 would each be transmitted to a display client and displayed in order at the normal rate, starting with frame 501 and ending with frame 516. Should a user of the display client submit a request for a fast forward presentation of the streaming video represented by frames 501-516, in one embodiment, presentation control 360 provides a subset of frames 501-516 to the display client to affect a fast forward presentation. A two-times normal speed (2×) fast forward presentation can be accomplished by transmitting only the I-frames (frames 501 and 509) and the P-frames (frames 502, 505, 508, 510, 513, and 516) in the forward order as frame stream 531. Assuming a display rate of 30 frames per second (fps), a 2× fast forward presentation rate can be achieved since the video content represented by 16 frames (approximately 0.53 seconds of video) is transmitted using 8 frames (approximately 0.27 seconds of video). Similarly, an 8× fast forward presentation rate can be achieved by providing only I-frames (frames 501-509) as frame stream 532 for 0.067 seconds worth of video. In the previous example the number of I-frames to the total number of frames and the number of I-frames and P-frames to the total number of frames resulted in a ratio of 2:16 (1:8) and 8:16 (1:2) respectively. Since the frame display rate of the display client remains unchanged, the video content of frames 501-516 is displayed in reduced time by displaying only one-half or one-eighth of frames 501-516 at the same frame display rate.

It will be appreciated the ratios of certain types of frames to other types may not be directly translated into a desired fast forward presentation rate in many encoded video data. For example, videos having less motion tend to have more B-frames than videos having more motion. Accordingly, presentation control 360, in one embodiment, manages the selection of frames to be included in a subset of frames to be provided to a display client to achieve the desired fast forward presentation rate, or close to it. For example, if there are 3 I-frames for every 16 frames total, to achieve an 8× fast forward presentation rate, every third I-frame could be dropped and not transmitted. Likewise, the number of I-frames and P-frames can be altered to achieve a 2× fast forward presentation rate. Alternatively, the duration of the display of a certain frame can be altered to achieve a desired fast forward rate, (i.e. change the frame display rate). For example, if a 4× fast forward rate is desired and three I-frames and P-frames are transmitted as frame stream 531 to represent 16 frames worth of video, a ratio of 3:16 is achieved, which is not exactly a 4× fast forward rate. Accordingly, one of the frames can be displayed a second time so that 4 frames are displayed, changing the displayed frame to total frames ratio to 4:16, which is an exact 4× fast forward rate. While an exact rate often may be desired, in at least one embodiment, an approximate fast forward rate is acceptable and no further modifications of the display of frame stream 531 are needed. Although a 2× and an 8× fast forward presentation rate have been illustrated, other fast forward presentation rates may be implemented without departing from the spirit or the scope of the present disclosure.

It will also be appreciated that some modification of elements associated with each of the presented frames may be necessary. For example, the MPEG format often utilizes a presentation time stamp (PTS), decoding time stamp (DTS), and/or a program clock reference (PCR) associated with each frame to determine when the frame is to be decoded and/or displayed at the display client. By transmitting the frames without modifying some or all of these values, the display of the frames may be delayed until the previously determined time. For example, if frame 501 has an unmodified PTS of t=0.033 and frame 509 has an unmodified PTS of t=0.3, then there would be a delay of 0.267 seconds between the display of frame 501 and frame 509 when frame stream 532 is provided to the display client, thereby defeating the intended fast forward presentation rate. Accordingly, in at least one embodiment, the PTS, DTS, and/or PCR of each frame of frame stream 531 and/or 532 are modified as necessary to allow the frames to be displayed at the proper time. For example, the PTS of frame 509 can be modified from t=0.3 to t=0.066 when transmitted as part of frame stream 532 so that frame 509 is displayed at the appropriate time for an 8× presentation rate. In one embodiment, the modification of the PTS, DTS, and/or PCR is performed by presentation control 360 (FIG. 3). In another embodiment, the modification is made by a transcoder, such as transcoder 370 (FIG. 3) used to transcode the streaming video for output. Similarly, properties of the transmitted frames can be modified to comply with the capabilities and/or constraints of the display clients. For example, frames to be transmitted can be downscaled to comply with a bandwidth limitation of a transmission medium between the video server and the display client. Likewise, the PTS and/or DTS value for frames can be adjusted when other frames are removed from frame stream 532 or other frames (such as advertising video) are added.

By selecting a subset of frames 501-516, the video content represented by frames 501-516 can be presented at a fast forward rate by providing the subset of frames having a fast forward presentation sequence. However, in order to be able to output the subset of frames 501-516, the location of these frames in video database 340 or at a video source must be known beforehand in order to access them in a real-time fashion. Without prior knowledge, the video data stored in video database 340 or at a video source generally has to be searched; a relatively slow and tedious process that often introduces an unacceptable delay. For example, if a user were to be viewing streaming video at a normal playback rate and then requested the video to be presented at an 8× fast forward rate, a video server without a frame index generally would have to search the video data, such as by bit parsing, to find the next I-frame, output the I-frame, search the video data again to find the next I-frame, output the next I-frame, and so on. However, because of the nature of how video data is often stored, it is often difficult to determine and locate I-frames in sequence in real-time, even when prediction methods are used. As a result, the video server would likely be unable to provide the fast forward presentation of the streaming video in real-time. However, by implementing frame index 530, certain frames can be located quickly, allowing a video server to provide the video in real-time according to a desired presentation mode.

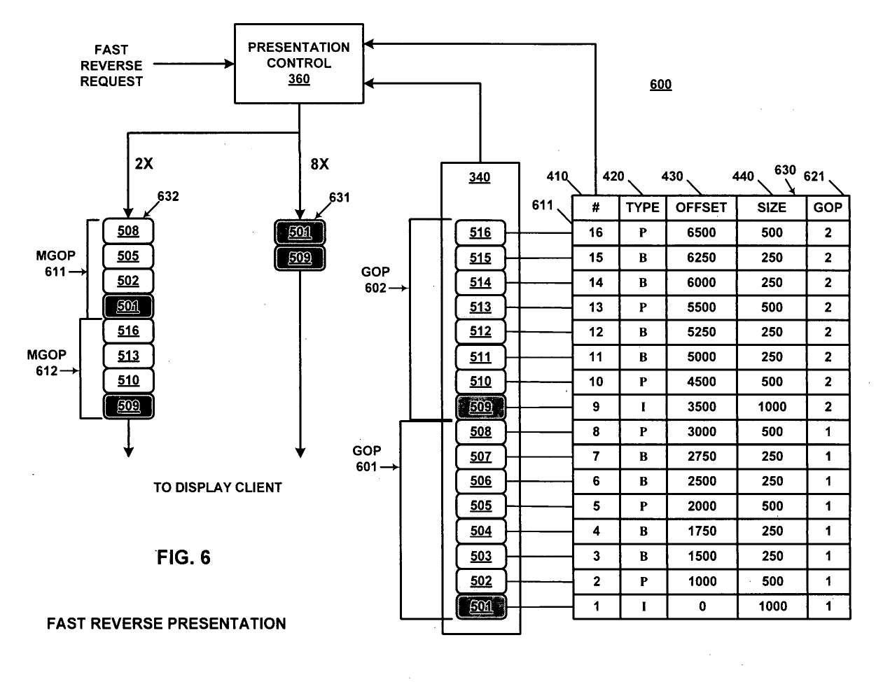

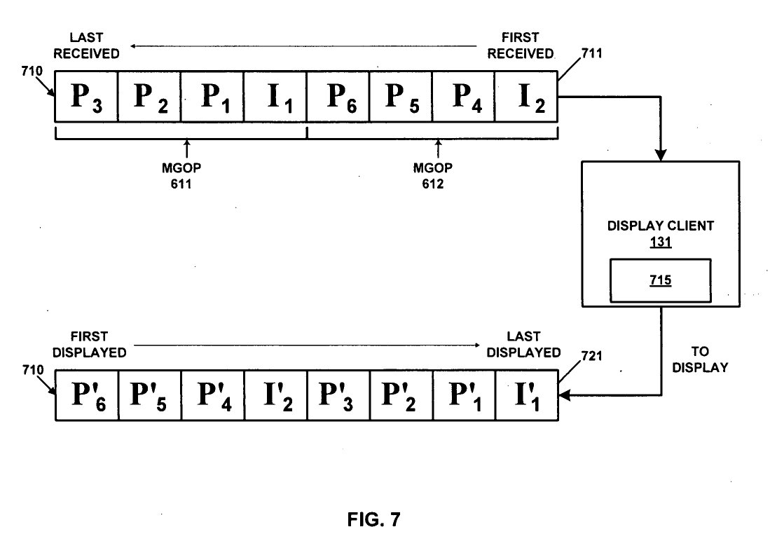

Referring to FIGS. 6-7, a method for implementing a fast reverse presentation mode is illustrated in accordance with at least one embodiment of the present disclosure. As illustrated in fast reverse scenario 600, frames 501-516 are stored in video database 340. In this example, frames 501 and 509 are I-frames, frames 502, 505, 508, 510, 513, and 516 are P-frames, and frames 503, 504, 506, 507, 511, 512, 514, and 515 are B-frames. In this example, the associated frame index 630 having frame index entries corresponding to frames 501-516, such as frame index entry 611 for frame 516, was generated at the time that frames 501-516 were stored in video database 340.

As with the fast forward presentation mode discussed previously with respect to FIG. 5, in one embodiment, a fast rewind presentation mode is implemented by providing a subset of frames 501-516 to a display client. However, unlike the fast forward presentation, the frames are presented in a reverse presentation sequence. In a normal playback, frame 501 is displayed first and frame 516 is displayed last. To generate a fast reverse presentation rate, this presentation sequence is partially reversed. In at least one embodiment, closed groups-of-pictures (GOPs), such as GOP 601-602, of frames 501-516 are identified. The GOP to which a certain frame belongs can be recorded as GOP value 621 of the associated frame index entry. For example, frame index entry 611 associated with frame 516 has a GOP value of 2 since it is in the second GOP of frames 501-516. After the GOPs of the video data are identified, a subset of the frames of each GOP is provided in the opposite order in which the GOPs are received. Accordingly, in one embodiment, the reverse presentation sequence includes reversing the order of the GOPs, but keeping the forward order of the frames within the GOPs.

To illustrate, an 8× fast reverse presentation rate, represented by frame stream 632, is generated by providing a subsets comprising the I-frames of GOPs 601-602. The I-frames are then provided to a display client in a reverse order of the forward order of their associated GOP. Since frame 509 is in the second GOP (GOP 602), it is provided first, while frame 501 is provided last since frame 501 is in the first GOP (GOP 601). Since the ratio of total frames to provided frames is 16:2, the fast reverse presentation rate is 8× the normal playback rate.

Likewise, presentation control 360 can provide the encoded video data at a 2× fast reverse presentation rate by transmitting a subset of the I-frames and P-frames of GOPs 610-602 in a reverse GOP sequence. For example, modified GOP (MGOP) 612 includes I-frame 609 and P-frames 510, 513, and 516 of GOP 602. MGOP 611 includes I-frame 501 and P-frames 502, 505, and 508 of GOP 601. Since GOP 601 is received first and GOP 602 is received last, the frames of MGOP 612 are provided first and the frames of MGOP 611 are provided last as frame stream 632. Note that although the order of GOP 601-602 is reversed from the forward order as MGOP 611 and MGOP 612, the order of the subset of frames within MGOP 611 and MGOP 612 remain unchanged. The ratio of total frames to transmitted frames is 16:8 resulting in a fast reverse rate of 2× the normal presentation rate.

In at least one embodiment, index frame 630 is instrumental in the generation of frame streams 631-632. As discussed previously with reference to the fast forward presentation of FIG. 5, without prior knowledge of the order, type, size and location of frames 501-516, it generally would be difficult and time-consuming to locate the desired subset of frames and provide them in a reverse order. In addition, like the fast forward presentation of FIG. 4, the PTS, DTS, and/or PCR may need to be modified. For example, if frame 501 has a forward presentation PTS of t=0.3 seconds and frame 509 has a forward presentation PTS of t=0.56 seconds, if provided with unmodified PTS values as frame stream 632, the display client would buffer frame 509 and display it after frame 501 had been displayed. Accordingly, the PTS value could be modified for frame 509 and 501 to be t=0.33 and t=0.66 respectively to have frame 501 displayed after frame 509.

It would be appreciated that frame stream 632 would not be decoded properly if a display client were to decode the frames in the reverse sequence in which frame 632 is received, even in the absence of B-frames. For example, decoding frames 509, 510, 513, and 516 in the provided sequence would result in a forward presentation of video content of these frames. Then when frame 501 was decoded and displayed, there would be a temporal jump backwards, and then a forward progression as frames 502, 505, and 508 are decoded. Accordingly, in at least one embodiment, the display client decodes a subset of frames (MGOP 611-612) as it is received and then displays the subset of frames in a reverse display sequence. As illustrated in FIG. 7, as MGOP 612 is received, the encoded frames, such as encoded I-frame 711, of MGOP 612 are decoded as they would be in a forward presentation sequence and stored in a buffer. The decoded frames, such as decoded I-frame 721, are then retrieved from the buffer and displayed in a reverse display sequence. For example, the I-frames (I) and P-frames (P) of video data received by video provider 120 (FIG. 1) could include frames I₁, P₁, P₂, P₃, I₂, P₄, P₅, and P₆, with I₁ received first and P₆ received last. In this case, MGOP 611 includes I₁, P₁, P₂, and P₃, and MGOP 612 includes frames I₂, P₄, P₅, and P₆.

Since the frames of MGOP 611 are prior to the frames of MGOP 612 in the normal presentation sequence, the frames of MGOP 612 are provided first to a display client for a fast reverse presentation rate. Display client 131 decodes the frames of MGOP 612 and stores the decompressed frames (P′ and I′) in video buffer 715. The display client then provides the frames for display on a display device in a reverse display sequence compared to a forward display sequence. In this case, the first reverse subsequence would be P′₆ [symbol] P′₅ [symbol] P′₄ [symbol] I′₂. The process is then repeated for MGOP 611 to generate the second reverse subsequence of P′₃ [symbol] P′₃ [symbol] P′₁ [symbol] I′₁. As a result, the display sequence for frame stream 632 would be the sequence of P′₆ [symbol] P′₅ [symbol] P′₄ [symbol] 1′₂ [symbol] P′₃ [symbol] P′₃ [symbol] P′₁ [symbol] I′₁, which is the reverse order of the original received frame display sequence. In instances where the frame stream includes only I-frames, such as frame stream 631, the display client can immediately display each I-frame as it is received since the I-frames are already provided in reverse order by presentation control 360.

As with the fast forward presentation mode discussed previously, the display rate of the frames of frame streams 631-632 can be modified to achieve a desired fast reverse presentation rate. Likewise, the number of frames included in each MGOP can be altered to achieve a certain ratio of transmitted frames to total frames. Although a 2× and an 8× fast rewind presentation rate have been illustrated, other fast forward presentation rates may be implemented without departing from the spirit or the scope of the present disclosure.

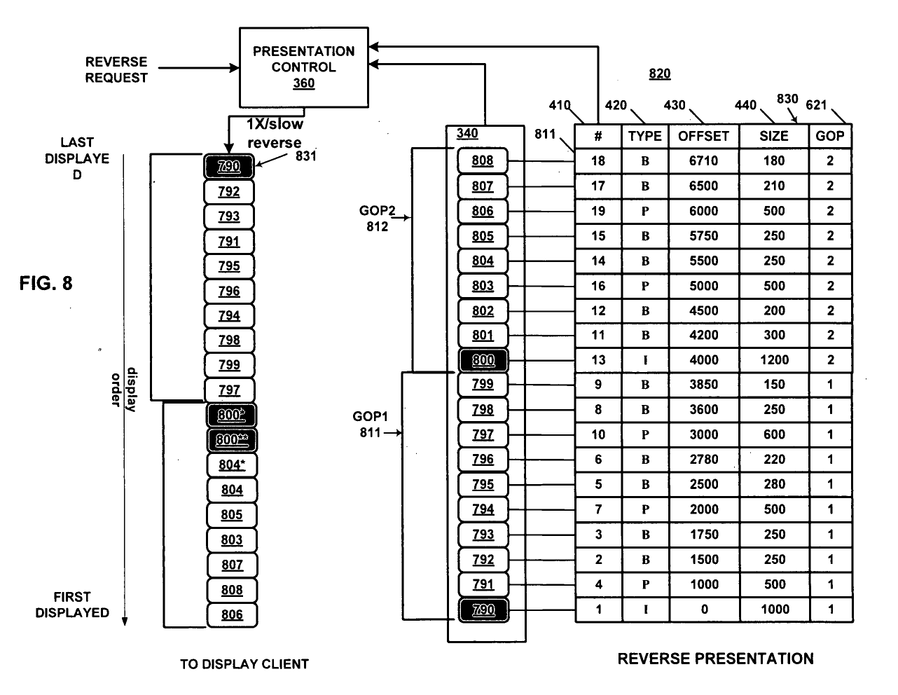

Referring to FIGS. 8-10, a method for implementing a reverse presentation rate is illustrated in accordance with at least one embodiment of the present disclosure. As illustrated in reverse scenario 820, frames 790-808 are stored in video database 340. In this example, frames 790 and 800 are I-frames, frames 791, 794, 797, 803, and 806 are P-frames, and frames 792, 793, 795, 796, 798, 799, 801, 802, 804, 805, 807, and 808 are B-frames. In this scenario, the associated frame index 830 having a frame index entry associated with each of frames 790-808, such as frame index entry 811 associated with frame 808, was generated at the same time that frames 790-808 were stored in video database 340.

In a normal-speed forward playback, frames 790-808 would each be transmitted to a display client and displayed in order of the forward presentation sequence, starting with frame 790 and ending with frame 808. Should a user of the display client submit a request for a reverse presentation of the streaming video represented by frames 790-808, in one embodiment, presentation control 360 provides frames 790-808 in a reverse presentation sequence for display as a normal-speed reverse presentation at the display client. As discussed previously, the GOPs of the received video data are identified, such as GOPs 811 and 812. As illustrated with GOP2 entry 808, frame index entries 811 of frame index 830 can include a GOP value of 2 indicating frame 808 is associated with GOP 812.

It should also be noted that while some streams may choose to start each GOP with the frame sequence I-frame [symbol] P-frame, and so on, it is possible to have GOPs that start as I-frame [symbol] B*-frame [symbol] B**-frame [symbol] P-frame, in this case, the frames marked B* and B** required the previous last reference frame from the previous GOP to be decoded. Referenced frames can only be I-frames or P-frames. As is known in the art, B-frames are reconstructed by taking information from a previous reference frame and a future reference frame. In such a scenario, without the presence of an I-frame or P-frame to form the 2^{nd} reference frame, the B-frames in each GOP after a single I-frame cannot be reconstructed unless that last reference frame from a previous GOP is also constructed. If the last reference frame from the previous GOP has to be reconstructed, then we have to reconstruct all the P-frames in between the last P-frame and the starting I-frame. While such a task can be performed, it generally requires storage of a previous GOP, which results in increased storage requirements, which then can result in increased cost.

As with the other presentation modes, the PTS, DTS, and/or PCR values may need to be modified by presentation control 360 and/or a transcoder for the frames to be displayed in the right order and at the right time. Alternatively, rather than modify the PTS, DTS, and/or PCS for each frame as it is transmitted to a display client for a fast forward, fast reverse, or reverse presentation, in one embodiment, the display client can be enabled to handle timing of the presentation of the frames.

As with the fast reverse presentation discussed previously, a normal rate reverse presentation is provided to a display client by providing GOPs 811-812 in reverse order (compared to their forward presentation sequence) but keeping the forward sequence of the frames of each of GOPs 811-812 the same. However, unlike the fast reverse presentation, in one embodiment all of the frames of a GOP are provided, rather than a subset. As a result, a normal rate reverse sequence results when GOPs 811-812 are presented at a normal rate, but in a reversed presentation sequence. To illustrate, presentation control 360, using frame index 830, identifies those frames of GOP 812 (frames 800-808) and provides the frames of GOP 812 in a forward presentation sequence as the first part of frame stream 831 since GOP 812 is received last in the forward sequence by a video provider. Likewise, those frames of GOP 811 (frames 801-805) are provided in a forward presentation sequence as the remainder of frame stream 831 since GOP 811 was received first by the video server.

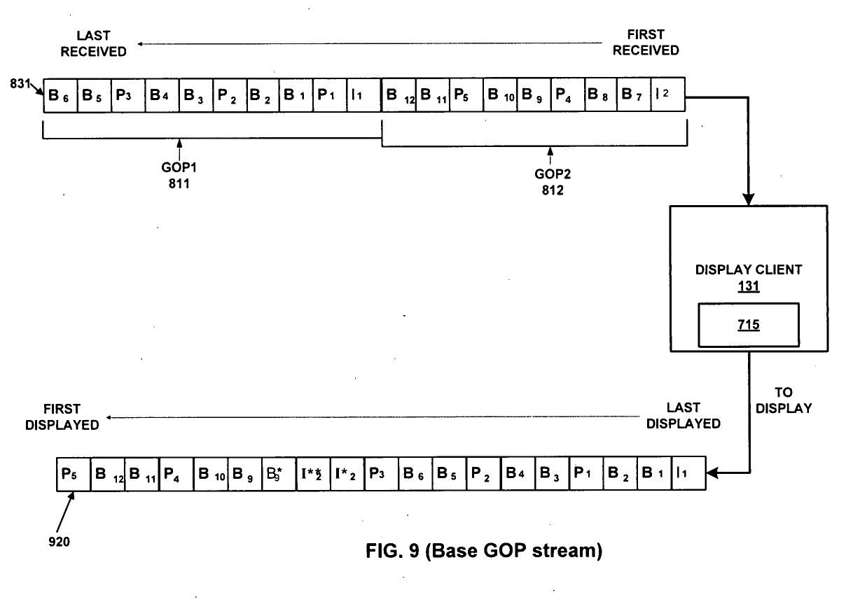

As with the fast reverse presentation mode discussed previously, the display client decodes the frames of each GOP as each GOP is received, stores the decoded frames of the GOP in a buffer, and then displays the frames of the GOP in a reverse display sequence. The next GOP is received and the process is repeated. In the following discussion of FIG. 9, the video frame sequence of the video received by a video server is I₁, P₁, B₁, B₂, P₂, B₃, B₄, P₃, B₅, B₆, I₂, B₇, B₈, P₄, B₉, B₁₀, P₅, B₁₁, B₁₂. As illustrated in FIG. 9, GOP 812 (having encoded frames I₂, B₇, B₈, P₄, B₉, B₁₀, P₅, B₁₁, B₁₂) of frame stream 831 is received by buffer 715 of display client 131 before GOP 811. Display client 131 then decodes the encoded frames of GOP 812 to generate the decoded frames I₂, B₇, B₈, P₄, B₉, B₁₀, P₅, B₁₁, B₁₂. Note that since B₇ and B₈ occur immediately following I₂, a second reference frame is not available for decoding of B₇, B₈ since it has not yet been provided to display client 131. Accordingly, in one embodiment, display client 131 does not attempt to decode B₇ or B₈ and simply ignores them. Note also that B9 can be decoded since the reference frames I₂ and P₄ are available. This is presented in the display sequence 920 as I*₂, I**₂, B*₉. Note that in ignoring the missing frames, two frames can be displayed in the time reserved for four frames. For example, I₂ could be displayed for two time periods and B₉ for two time periods, I₂ could be displayed for three time periods, or B₉ could be displayed for three time periods.

Alternatively, in another embodiment, B₃ would be omitted from frame stream 831 by the video server providing frame stream 831. For example, presentation control 360 (FIG. 3) could analyze frame stream 831 to determine any B-frames that could not be decoded as part of frame stream 831. In this case, any B-frames found to be problematic could be excluded from frame stream 831 by presentation control 360, thereby avoiding the problem of how to decode the problematic B-frame. Excluding these types of B-frames also has the benefit of reducing the amount of bandwidth needed to transmit frame stream 831.

As with the fast reverse presentation mode, display client 131 provides the decoded frames of GOP 812 (minus the decoded version of B₃) in the opposite order of the forward display sequence. Accordingly, the decoded frames of GOP 812 are provided as display stream 920 to a display in the order: P′₅ [symbol] B′₁₂ [symbol] B₁₁ [symbol] P′₄ [symbol] B′₁₀ [symbol] B′₉ [symbol] B′*₉ [symbol] I′**₂ [symbol] I′*2. Next, the frames of GOP 811 (I₁, P₁, B₁, B₂, P₂, B₃, B₄, P₃, B₅, B₆) are decoded to generate decoded frames I′₁, B′₁, B′₂, P′₁, B′₃, B′₄, P′₂, B₅, B₆, P₃. As with the decoded frames of GOP 812, the decoded frames of GOP 811 are output in reverse order as the last part of display stream 920, resulting in the decoded frame order for GOP 811: P′₃ [symbol] B′₆ [symbol] B′₅ [symbol] P′₂ [symbol] B′₄ [symbol] B′₃ [symbol] P′₂ [symbol] B′₄₂ [symbol] B′₁ [symbol] I′₁. The resulting display stream 920 is P′₅ [symbol] B′₁₂ [symbol] B′₁₁ [symbol] P′₄ [symbol] B′₁₀ [symbol] B′₉ [symbol] B′*₉ [symbol] I′**₂ [symbol] I′*₂ [symbol] P′₃ [symbol] B′₆ [symbol] B′₅ [symbol] P′₂ [symbol] B′₄ [symbol] B′₃ [symbol] P′₂ [symbol] B′₄₂ [symbol] B′₁ [symbol] I′₁, which is the reverse order of the original forward sequence of the received video data (minus the frames that cannot be decoded efficiently B₇, B₈).

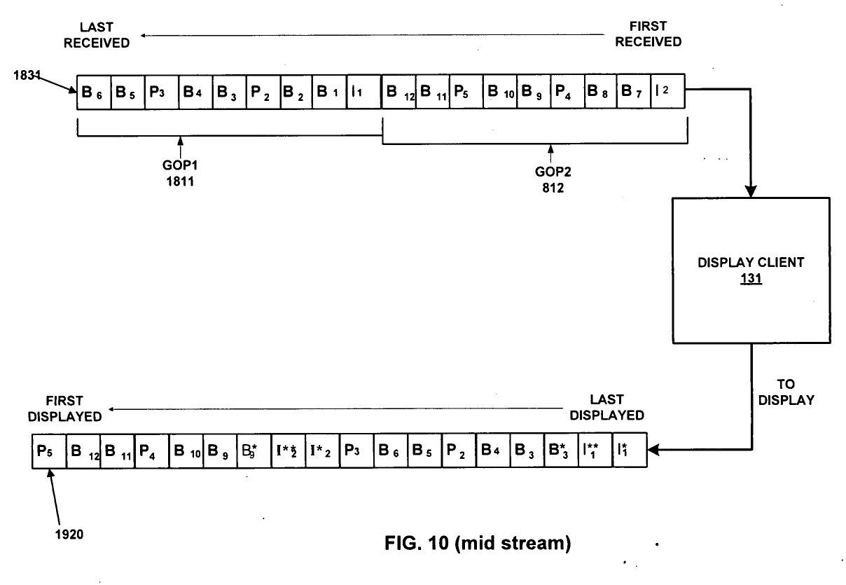

Referring to FIG. 10, a frame sequence of two GOPS that are similar to FIG. 9 are illustrated. With reference to FIG. 10 versus FIG. 9, the primary difference is that the earliest GOP 1811 of frame stream 1831 starts with an I-frame [symbol] B-frame sequence instead of an I-frame [symbol] P-frame [symbol] B-frame sequence (as with GOP 811 of frame stream 831 of FIG. 9). The former is more likely to occur in the middle of a stream where the creator of the original stream has decided on further data compression to generate more B-frames instead. The behavior of the presentation method in such a case is similar. In this case, frames B₁ and B₂ are handled in the same way B₇ and B₈ were treated in FIGS. 8-9 by replacing them with other available frames to display. The resulting display stream (display stream 1920) is illustrated in FIG. 10.

Referring to FIGS. 11-15, a method for implementing a pause and/or jump in the presentation of streaming video is illustrated in accordance with at least one embodiment of the present disclosure. A pause in the presentation of streaming video 1010 having frames 1001-1008 can be initiated by a display client or by the provider of the streaming video, such as video server 120. Recall that pause request 1035 can be transmitted directly from display client 131 to video server 120, transmitted via a network, or transmitted using a remote control device, such as an IR remote control receiver, as an intermediate. In the following discussion, it is assumed that pause request 1035 is transmitted via network, such as external network 205, therefore a significant latency is likely to exist between the transmission of pause request 1035 by display client 131 and the receipt of pause request 1035 by video server 120. For ease of illustration, the latency introduced by external network 205 is assumed to be equivalent to the amount of time needed to display three frames of video at a certain frame rate (for example, 3 frames at 30 fps=0.10 seconds). Note, however, that the latency is generally longer and often can be measured in seconds.

FIG. 11 illustrates the moment that pause request 1035 is initiated (time t=0). Pause request 1035 can be initiated by a user, such as by pressing a pause button at display client 131. Alternatively, pause request 1035 could be initiated by an internal process of display client 131, such as resulting from the countdown of an internal timer. For purpose of discussion, it is assumed that the time difference between when pause request 1035 is initiated and when pause request 1035 is generated and output by display client 131 is negligible in comparison to the latency of external network 205.

At the time pause request 1035 was generated, frames 1001, 1002, and 1003 have previously been transmitted to display client 131 and stored in video buffer 715. At the time of the generation of pause request 1035, decoder 1020 of display client 1020 had retrieved and decoded frame 1001 and provided the decoded frame for display on display device 1030. Likewise, at the same time, video server 120 was in the process of providing frame 1004 to display client 131.

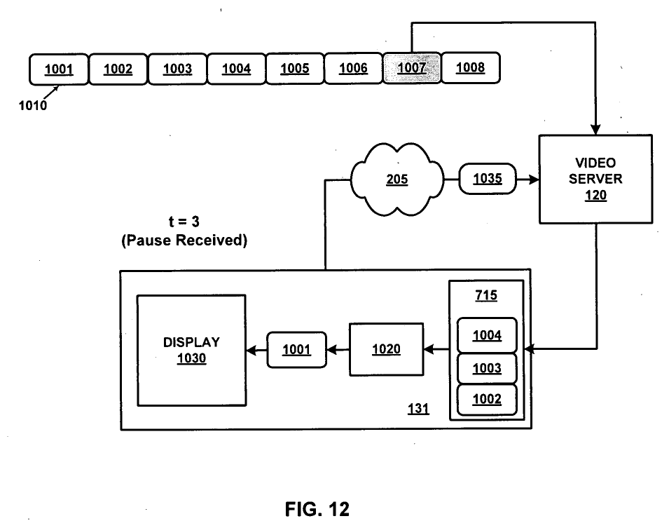

FIG. 12 illustrates the moment that pause request 1035 is received by video server 120 after a latency of 3 frame display periods (time t=3) introduced by external network 205. Because of the latency between the transmission of pause request 1035 and the reception, video server 120 has progressed in the sequence of frames 1001-1008 to frame 1007 and is in the process of providing frame 1007. During the period between the transmission of pause request 1035 and the reception of pause request 1035, video provided 120 provided three frames 1005, 1006, and 1007 to display client 131. However, in this example, buffer 715 can only buffer a maximum of three encoded frames of video. Accordingly, display client 131 was unable to buffer frames 1005, 1006, and 1007 in buffer 715.

Since video server 120 received pause request 1035 while transmitting frame 1007, if it were to resume transmitting frames starting at frame 1008 upon a receipt of a resume request, frames 1005-1007 would be unavailable for display, causing a jump in the continuity of the display of streaming video 1010, thereby defeating the purpose of the pause operation. Accordingly, pause request 1035 includes one or more indicators of the status of display client 131. For example, in one embodiment, pause request 1035 includes a last frame displayed value to indicate the last frame displayed when pause request 1035 was generated (i.e. frame 1001). Likewise, pause request 1035 can include a last frame received value to indicate the last frame received during the generation of pause request 1035 (i.e. frame 1004). The last frame displayed value and/or last frame received value can be represented by a time value. For example, if streaming video 1010 is displayed at a frame rate of 30 fps, then the last frame displayed value can be represented by the time value t=0.0 seconds, representing the first frame (frame 1001). Likewise, the last frame received value can be represented by the time value t=0.1 seconds, representing frame 1004. Pause request 1035 can also include a buffer capacity value or buffer status value to indicated the capacity of buffer 715.

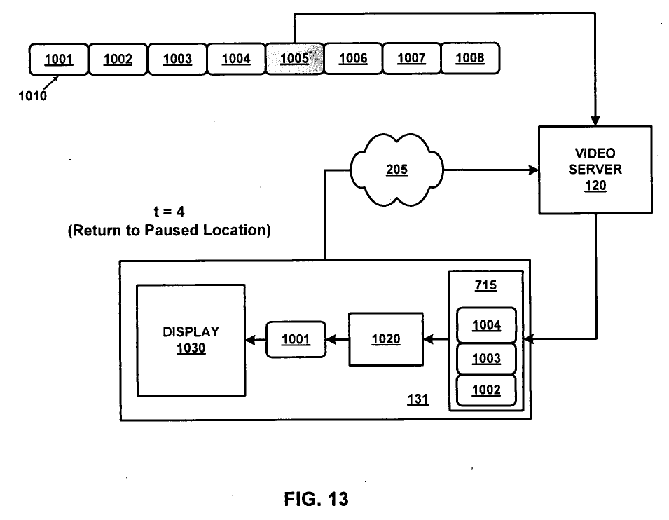

Referring to FIG. 13, video provider 120 can use the indicators provided as part of pause request 1035 to accommodate for a pause in the presentation of streaming video 1010 and prepare to resume providing the video data to compensate for the latency between transmission and reception of pause request 1035. For example, by knowing the last frame received and the buffer capacity of buffer 715, video provider 120 can “rewind” to the next frame subsequent to last frame received and provide the next one or more frames during the pause interval until buffer 715 is filled. For example, if frame 1004 was the last frame received by display client 131 and buffer 715 can buffer up to five frames, video provider 120 could provide frames 1005 and 1006 to display client 131 to fill up buffer 715 during the pause interval. However, as stated previously, buffer 715 can only buffer up to three frames in this example. Therefore, the last frame (frame 1004) to fill buffer 715 is the same frame buffered at the time that pause request 1035 was transmitted (at t=0). Likewise, video server 120 can use the pause interval to locate the next frame (frame 1005) to be transmitted to display client 131 when playback of the video is resumed by display client 131. If buffer 715 is full at the time that display client 131 generated pause request 1035, then the next frame to be provided would the frame immediately subsequent in the frame presentation sequence to the last frame stored in buffer 715. If buffer 715 is filled by subsequent frames during a pause interval, the last frame can include the frame immediately subsequent to the last frame of stored during the pause interval. In one embodiment, a frame index, as discussed previously, is used to assist in the location of the next frame.

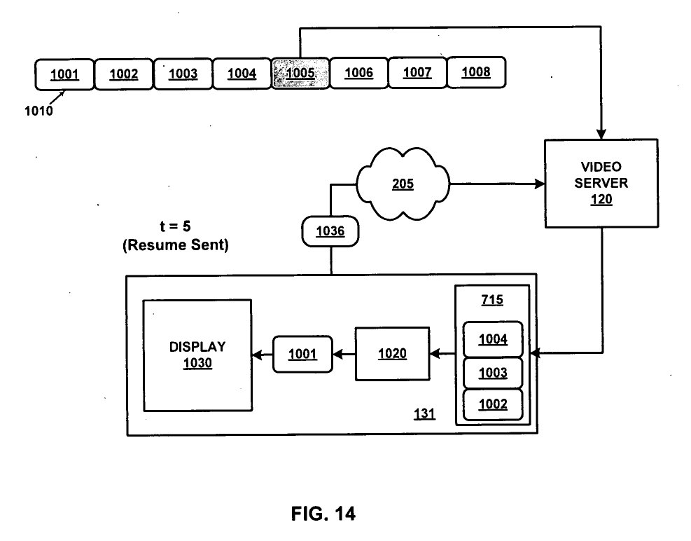

As illustrated in FIG. 14, resume request 1036 is initiated and generated by display client 131. As with pause request 1035, the difference between the initiation of resume request 1036 and the output of resume request 1036 is assumed to be comparatively negligible. At the time of the generation of resume request 1036, decoder 1020 begins retrieving and decoding frames from buffer 715 for display.

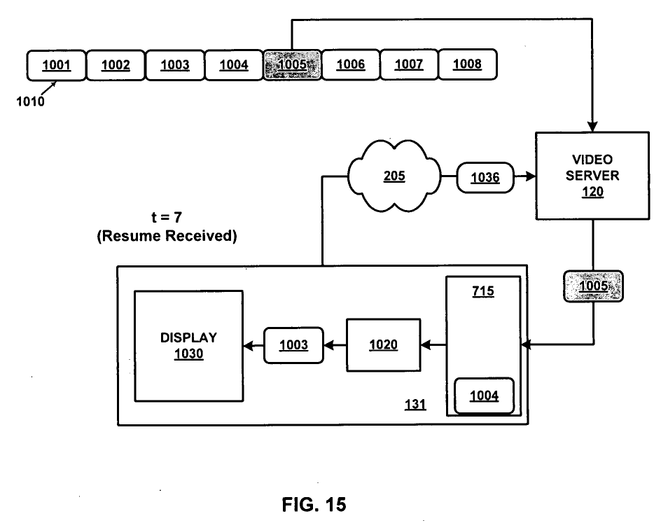

After the latency resulting from external network 205 as a transmission medium, resume request 1036 is received by video server 120 at time t=7, as illustrated in FIG. 15. Status indicators of display client 131, such as the time of generation of pause request 1035, the last frame received and the last frame displayed can be included in resume request 1036 in addition to, or instead of, in pause request 1035. With knowledge of the status of display client 131, video server 120 returns to the frame (frame 1005) following the last frame that was buffered in buffer 715, which also happens to be the last frame (frame 1004) received by display client 131 at the time of generation of pause request 131. Video server 120 then provides frames in sequence to display client 131 starting at frame 1005. During the latency between transmission and receipt of resume request 1035, decoder 1020 retrieves and decodes frames from buffer 715 for display on display device 1030.

In addition to a pause in the presentation of video data, display client 131 can request a shift in the presentation of the video, where the jump is represented by a certain number of frames and/or a certain amount of time. For example, pause request 1035 can include a jump request that specifies the number of frames by which the video is to be shifted, as well as the current frame being displayed at display client 131. Video server 120, after receiving the pause/jump request (pause request 1035), can move forward by the requested number from the currently displayed frame in the presentation sequence of streaming video 1010 start providing the frames subsequent to that frame.

In at least one embodiment, video server 120 generates a frame index, such as frame index 330 (FIG. 3), of streaming video 1010. This frame index is then used to assist in locating the desired frames in the data representing streaming video 1010. For example, the frame index can be used to move back from frame 1007 to frame 1005 when pause request 1036 is received (t=7). Without the frame index, it generally is difficult to jump to different frames in the frame sequence of streaming video 1010. For example, to go from frame 1007 to frame 1005 without a frame index, video server 120 could bit parse the data of streaming video 1010, a relatively intensive process. Alternatively, video server 120 can predict where the data representing frame 1005 is in relation to the data representing frame 1007 and then search around the predicted location, which is still a relatively intensive process.

By using a frame index and/or display client indicators as part of pause requests and/or resume requests, a pause in the presentation of video and the resuming of the presentation can be enacted in real-time at a display client in spite of the latency involved in transmitting the requests. However, if the latency involved in the transmission of the resume request exceeds the capacity of the buffer of the display client, starvation of decoder at the display client could occur. Therefore, it will be appreciated that care should be taken to avoid starvation, such as by a display client with a buffer having enough capacity to outlast foreseeable latency periods.

The various functions and components in the present application may be implemented using an information handling machine such as a data processor, or a plurality of processing devices. Such a data processor may be a microprocessor, microcontroller, microcomputer, digital signal processor, state machine, logic circuitry, and/or any device that manipulates digital information based on operational instruction, or in a predefined manner. Generally, the various functions, and systems represented by block diagrams are readily implemented by one of ordinary skill in the art using one or more of the implementation techniques listed herein. When a data processor for issuing instructions is used, the instruction may be stored in memory. Such a memory may be a single memory device or a plurality of memory devices. Such a memory device may be read-only memory device, random access memory device, magnetic tape memory, floppy disk memory, hard drive memory, external tape, and/or any device that stores digital information. Note that when the data processor implements one or more of its functions via a state machine or logic circuitry, the memory storing the corresponding instructions may be embedded within the circuitry that includes a state machine and/or logic circuitry, or it may be unnecessary because the function is performed using combinational logic. Such an information handling machine may be a system, or part of a system, such as a computer, a personal digital assistant (PDA), a hand held computing device, a cable set-top box, an Internet capable device, such as a cellular phone, and the like.

In the preceding detailed description of the figures, reference has been made to the accompanying drawings which form a part thereof, and in which is shown by way of illustration specific embodiments in which the disclosure may be practiced. These embodiments are described in sufficient detail to enable those skilled in the art to practice the disclosure, and it is to be understood that other embodiments may be utilized and that logical, mechanical, chemical and electrical changes may be made without departing from the spirit or scope of the disclosure. To avoid detail not necessary to enable those skilled in the art to practice the disclosure, the description may omit certain information known to those skilled in the art. Furthermore, many other varied embodiments that incorporate the teachings of the disclosure may be easily constructed by those skilled in the art. Accordingly, the present disclosure is not intended to be limited to the specific form set forth herein, but on the contrary, it is intended to cover such alternatives, modifications, and equivalents, as can be reasonably included within the spirit and scope of the disclosure. The preceding detailed description is, therefore, not to be taken in a limiting sense, and the scope of the present disclosure is defined only by the appended claims.

What is claimed is:

1. In a system comprising a video server and a display client connected via a network, a method comprising:
providing video data from the video server to the display client, the video data including a plurality of frames having a presentation sequence;
receiving, at the video server, a pause request from the display client while providing the video data to the display client; and
determining, at the video server in response to receiving the pause request, a last frame of the plurality of frames provided to the display client at a time corresponding to generation of the pause request at the display client.

2. The method of claim 1, further comprising:
receiving, at the video server, a resume request from the display client following receipt of the pause request; and
providing, from the video server to the display client in response to receiving the resume request, a next frame of the plurality of frames following the last frame in the presentation sequence.

3. The method of claim 2, wherein the next frame is immediately subsequent to the last frame in the presentation sequence.

4. The method of claim 2, wherein:
the pause request comprises a jump request indicating a shift in a presentation of the video data by a select number of frames; and
the next frame is subsequent to the last frame in the presentation sequence by the select number of frames.

5. The method of claim 2, wherein at least one of the pause request or the resume request comprises at least one selected from a group consisting of: an indicator identifying the last frame provided to the display client; and a time value representative of the last frame provided to the display client.

6. The method of claim 2, further comprising:
generating, at the video server, a frame index for the video data, the frame index comprising a plurality of frame index entries corresponding to the plurality of frames of the video data; and
wherein providing the next frame of the plurality of frames from the video server to the display client comprises identifying the next frame within the plurality of frames based on the frame index.

7. The method of claim 2, wherein providing the next frame from the video server to the display client comprises downscaling the next frame at the video server based on a bandwidth limitation of the network.

8. The method of claim 1, further comprising:
determining, at the video server, a buffer capacity of the display client based on a corresponding indicator of the pause request; and
providing, from the video server to the display client in response to receiving the pause request, a set of one or more frames following the last frame in the presentation sequence, wherein a number of frames included in the set of one or more frames is based on the buffer capacity.

9. The method of claim 8, further comprising:
generating, at the video server, a frame index for the video data, the frame index comprising a plurality of frame index entries corresponding to the plurality of frames of the video data; and
wherein providing the set of one or more frames from the video server to the display client comprises identifying the set of one or more frames within the plurality of frames based on the frame index.

10. The method of claim 8, wherein providing the set of one or more frames from the video server to the display client comprises downscaling at least one frame of the set of one or more frames at the video server based on a bandwidth limitation of the network.

11. A system comprising:
a video server comprising:
a presentation control to:
provide video data to a display client via a network, the video data including a plurality of frames having a presentation sequence;
receive a pause request from the display client via the network while providing the video data to the display client; and
determine, in response to receiving the pause request, a last frame of the plurality of frames provided to the display client at a time corresponding to generation of the pause request at the display client.

12. The system of claim 11, wherein the presentation control of the video server further is to:
receive a resume request from the display client following receipt of the pause request; and
in response to receiving the resume request, provide to the display client via the network a next frame of the plurality of frames following the last frame in the presentation sequence.

13. The system of claim 12, wherein the next frame is immediately subsequent to the last frame in the presentation sequence.

14. The system of claim 12, wherein:
the pause request comprises a jump request indicating a shift in a presentation of the video data by a select number of frames; and
the next frame is subsequent to the last frame in the presentation sequence by the select number of frames.

15. The system of claim 12, wherein the video server further comprises:
a recorder module to generate a frame index for the video data, the frame index comprising a plurality of frame index entries corresponding to the plurality of frames of the video data; and
wherein the presentation control identifies the next frame within the plurality of frames based on the frame index.

16. The system of claim 12, wherein the video server further comprises:
a transcoder to downscale the next frame based on a bandwidth limitation of the network.

17. The system of claim 11, wherein:
the video server is to determine a buffer capacity of the display client based on a corresponding indicator of the pause request; and
the presentation control is to provide, in response to receiving the pause request, a set of one or more frames following the last frame in the presentation sequence to the display client via the network, wherein a number of frames included in the set of one or more frames is based on the buffer capacity.

18. The system of claim 17, wherein the video server further comprises:
a recording module to generate a frame index for the video data, the frame index comprising a plurality of frame index entries corresponding to the plurality of frames of the video data; and
wherein the presentation control is to identify the set of one or more frames within the plurality of frames based on the frame index.

19. The system of claim 17, wherein the video server further comprises:
a transcoder to downscale at least one frame of the set of one or more frames based on a bandwidth limitation of the network.

20. The system of claim 17, further comprising:
the display client, wherein the display client is to generate the pause request and provide the pause request to the video server responsive to a remote control command from a user.

21. In a system comprising a video server and a display client connected via a network, a method comprising:
generating, at the video server, a frame index for video data, wherein the frame index comprises a plurality of frame index entries corresponding to a plurality of frames of the video data and wherein the plurality of frames has a presentation sequence;
providing the video data from the video server to the display client;
receiving, at the video server, a pause request from the display client while providing the video data to the display client;
determining, at the video server in response to receiving the pause request, a last frame of the plurality of frames provided to the display client at a time corresponding to generation of the pause request at the display client;
determining, at the video server, a buffer capacity of a buffer of the display client based on a corresponding indicator of the pause request;
identifying a set of one or more frames following the last frame in the presentation sequence based on the buffer capacity and the frame index, the set of one or more frames comprising a number of frames sufficient to fill the buffer of the display client;
providing the set of one or more frames to the display client in response to the pause request;
receiving, at the video server, a resume request from the display client subsequent to providing the set of one or more frames; and
identifying, at the video server, a next frame following the set of one or more frames in the presentation sequence in response and providing the next frame from the video server to the display client in response to receiving the resume request at the video server.
